(19) United States
(12) Patent Application Publication
(10) Pub. No.: US 2024/0202326 A1
(43) Pub. Date: Jun. 20, 2024

(54) Anomaly Detection on MIL-STD-1553 Dataset Using Machine Learning

(71) Applicant: Bowie State University, Bowie, MD (US)

(72) Inventors: Darsana Josyula, Crofton, MD (US); Francis Onodueze, Damascus, MD (US)

(73) Assignee: Bowie State University, Bowie, MD (US)

(21) Appl. No.: 18/081,934

(22) Filed: Dec. 15, 2022

Related U.S. Application Data
(60) Provisional application No. 63/291,026, filed on Dec. 17, 2021.

(51) Int. Cl. G06F 21/55

(52) U.S. Cl. CPC G06F 21/554

(57) ABSTRACT

The ability of several machine learning models to detect attacks that emulate normal non-periodical messages in the MIL-STD-1553 communication traffic were evaluated and the technical problems were identified, such as, for example, that the MIL-STD-1553 dataset is highly imbalanced and most models simply fail or produce poor results when classifying the data. Different machine learning algorithms were trained and then used to classify the MIL-STD-1553 dataset. A unique metric was advantageously identified to judge the performance of the machine learning models applied to highly imbalanced datasets.

### BACKGROUND

MIL-STD-1553 system is a communication platform published by the US Department of Defense (DoD) for the purpose of integrating other military systems. The MIL-STD-1553 communication system standard (referred hereafter as 1553 or aircraft system) defines the mechanical, electrical and functional characteristics of a serial data bus used with military avionics and spacecraft subsystems. It defines how data is received and transmitted to and from other systems. The 1553 standard was developed to achieve commonality and interoperability among military aircraft components. Some of the reasons for developing the 1553 standard are: cost savings over hosting individual systems, flexibility with the plug and play capability and logistic benefits like fewer number of one-of-a-kind parts that have to be maintained and stocked in inventory. The 1553 system is a legacy system that has been described as the most successful and internationally accepted military platform standard of all time. It was built over 45 years ago when attacks were not as sophisticated as they are now and lacks security features such as authentication. Subsequent systems built in later years are based on the communication protocol defined by the 1553 system. The usage of MIL-STD-1553 has expanded across the world for space applications, unmanned aerial vehicles and commercial vehicles.

The 1553 features the physical, the network interface, command/response protocol, time division multiplexing methodology and up to 31 remote terminals. Some of these remote terminals have the ability to set other remote terminals, thus making the platform vulnerable for a compromised remote terminal to modify network packets of legitimate messages. The 1553 system was not built to withstand today's security threats and is vulnerable to several kinds of attacks. In a typical operation of the 1553 system, a malicious remote terminal can impersonate a legitimate remote terminal for the purpose of changing the value of a request in order to generate false output or stop communication. The complete replacement of the 1553 aircraft system is close to impossible at this time because of the challenges of modifying an entire operational platform, coupled with the difficulty of replacing the main data transmission topology.

### BRIEF DESCRIPTION OF THE DRAWINGS

FIG. 1 illustrates the MIL-STD-1553 bus architecture.

FIGS. 2A and 2B illustrate AUC curves for certain models, in accordance with an embodiment of the present disclosure.

FIG. 3 depicts the cumulative accuracy score of the various machine learning models after classifying MIL-STD-1553 datasets, in accordance with an embodiment of the present disclosure.

FIG. 4 depicts the ratio of test to train samples in the datasets, in accordance with an embodiment of the present disclosure.

### DETAILED DESCRIPTION

Embodiments of the present disclosure will now be described with reference to the drawing figures, in which like reference numerals refer to like parts throughout.

One security analysis of the 1553 communication protocol resulted in a proposal to use a supervised sequence-based anomaly detection method that performs time interval analysis of messages by inspecting deviations from normal time cycles. That analysis involved two experiments—one on an operational testbed with 1553 hardware and the other on 1553 system logs.

Another analysis focused on minimizing the amount of false alarm in datasets that contain a meaningful hierarchical structure by reducing the false positive rates of the intrusion detection system (IDS).

Embodiments of the present disclosure advantageously deploy machine learning models to determine how communication to and from the 1553 communication bus system can be classified as normal or malicious. The models are trained using publicly available sequential datasets. One focus of the present disclosure is anomalies that occur in the periodic messages. The sequences of message identifiers form the input to the machine learning models. The results from applying several machine learning models to classify normal data points (benign messages) and malicious data points (anomalous messages) on 1553 dataset are disclosed herein.

The present disclosure also includes a comparative analysis of the performance of machine learning models to classify sequential 1553 datasets for the purposes of detecting anomalies. The results produced by these machine learning systems are analyzed and their behavior towards classifying highly imbalanced datasets in general is discussed. Unique metrics were advantageously identified to judge the performance of the machine learning models applied to this highly imbalanced dataset.

MIL-STD-1553 is a military integration standard that defines the communication bus used for transmitting data between the bus controller and remote terminal. It was developed in 1973 and has seen several revisions since then. MIL-STD-1553B, a revision, was released in 1978 as a tri-services standard for the Air Force, Army, and Navy/Marine Corp.

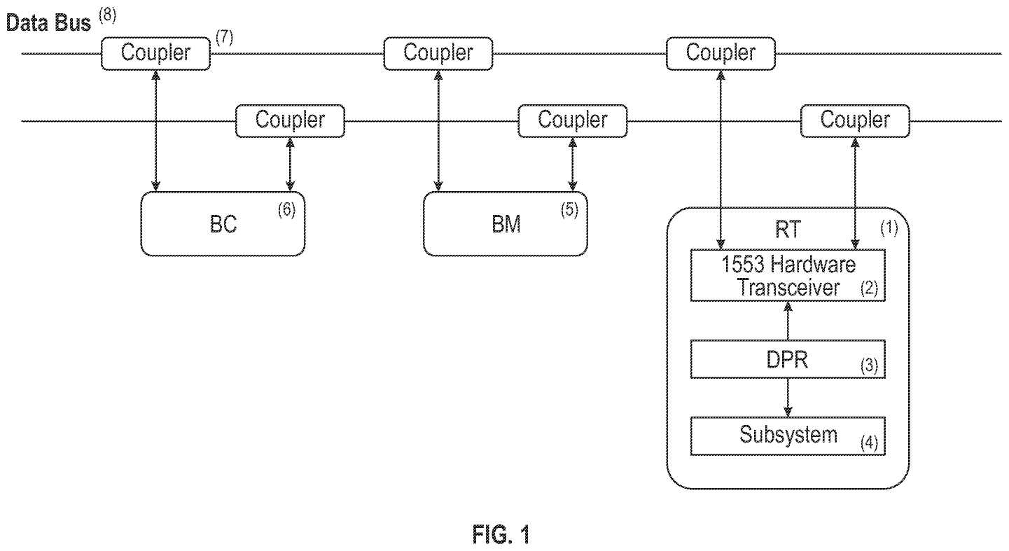

FIG. 1 shows the MIL-STD-1553 bus architecture. MIL-STD-1553 uses master-slave bus topology and includes, inter alia, remote terminal (RT) 1, bus controller (BC) 6, bus monitor (BM) 5, couplers 7 and data bus 8. Remote terminal 1 includes 1553 hardware transceiver 2, connected to a couplers 7 on data bus 8, and takes care of exchange of data with the subsystems through dual port RAM (DPR) 3. Bus controller 6 initiates commands to the remote terminals 1 and manages communication between the remote terminals 1 using command/response messages. Bus monitor 5 observes the state and operational mode of the systems and sub-systems by listening and collecting data from the data bus 8. Couplers 7 are responsible for isolating the hardware components connected to data bus 8 from one another to ensure that the malfunction or damage of one does not affect another. Data bus 8 is a physical component used to transmit messages between components connected to the 1553 platform.

Advantageously, BC 6 and/or BM 5 may include, inter alia, memory and one or more processors configured to execute software to monitor the message traffic on data bus 8, to classify and label the messages, and to determine whether an attack on the MIL-STD-1553 bus is occurring. The software may include one or more trained machine learning models, as discussed below.

The publicly available datasets are generated from simulated streams of MIL-STD-1553 communication messages. Each communication message has packets recorded on a 1553 bus simulator corresponding to a basic aircraft bus architecture. The bus architecture used to generate the messages includes a malicious remote terminal that injects packets simulating an attack on the aircraft. The streams are generated by recording about a minute of bus traffic with varying number of attacks to simulate differing attack occurrence ratios.

Each stream is split into sequences of messages. Each sequence contains the identifiers of ten consecutive messages. Every incoming message results in a new sequence. Thus, sequences overlap, and consecutive sequences may differ only by the first and last message identifier. Any sequence containing at least one malicious message that alters the aircraft behavior is labeled as MALICIOUS, otherwise it is labeled as NORMAL. Each data packet, data flow or data point is given one of these two classes to identify the kind of activity to which it belongs. Table 1 shows samples sequences of message identifiers in SPMF format.

Each dataset represents a stream of simulated 1553 traffic and is separated into training set and testing set. The training set consists of a set of normal messages; this set does not contain malicious messages. The test set contains both normal and malicious messages. The three datasets used differ in the rate of occurrence of attack messages (0.01%, 0.10%, 1.00%). Table 2 shows the format of MIL-STD-1553 simulated messages used herein.

The 1553 dataset is used to benchmark the ability of an IDS to detect remote terminal (RT) spoofing attacks that are camouflaged as normal non-periodic messages. Each negative sample indicates an attack and demonstrates how a malicious remote terminal can inject packets into the bus and cause one or more anomalies to an aircraft's operation. The 1553 dataset is also used to analyze the effect of differing attack occurrence rates on the evaluated IDS.

The 1553 dataset is a unique dataset in that there are samples of the anomalous class only in the test data set. Problems involving such kinds of dataset are categorized as one-class or extreme rare event classification. This categorization means that the chance of occurrence of an outlier is rare and any classifier may not have enough negative samples to form the basis for making correct prediction. In the case of datasets with a missing class in the train set, classical classification algorithms such as Naïve Bayes and SVM fail because they require data points from all the classes for training to be successful. The way the training data is sampled makes it nearly impossible for a machine learning model to decipher negative samples during the testing phase because the model may not have learned negative samples during training.

Extreme rare event problems like the ones that occur in the 1553 dataset may be studied using outlier detection where the number of outliers can be said to under-represent a given category. Outlier detection often finds applications in detecting fraud, diagnosing abnormal health changes in patients, detecting unauthorized access or suspicious traffic patterns in computer networks, detecting abnormal running conditions in aircraft engine, tracing anomalies in pipelines, surveillance of military equipment and many other areas. The study of outliers has given rise to methodologies such as distance-based and density-based outlier detection techniques.

Some of the challenges include training datasets that only contain positive samples (normal data), whereas the testing datasets contain negative examples (malicious samples) as well, making the dataset highly imbalanced, and a limited number of data points available for training. Thus, the model needs to classify positive and negative samples after training only on a few positive samples. While a balanced dataset is ideal for training, most conventional machine learning systems concentrate on ratios ranging from 1:4 up to 1:100. Imbalance ratios of 1:1000 and 1:10000 can throw off the machine learning systems yielding severely skewed results as shown herein.

Another challenge is related to practicality. For any machine learning system to be practically applicable, it must yield close to zero false positives (malicious data incorrectly classified as normal). This is because the 1553 communication bus is a military mission critical system, and any false positive would mean the intrusion detection system has failed to detect an attack that can lead to significant malfunctions and ultimately a crash of the aircraft. False negatives are not good and can hinder the smooth running of the communication system, but they may not cause as devastating an effect as false positives. Therefore, embodiments of the present disclosure provide machine learning models or systems that are trained to detect malicious activities in the 1553 non-sequential message datasets with particular attention paid to false positives.

A description of each machine learning technique that forms the basis of each embodiment of the present disclosure follows.

### Multilayer Perceptron (MLP)

MLP is a class of feed forward artificial neural network (ANN) that is composed of multiple layers of perceptron and makes use of the concept of back propagation for training. The layers of perceptron in MLP are defined as input layers, output layers and hidden layers. The number of layers is independent of the problem but contributes to the ability of the network to build context and learn the data. MLP has been widely applied to regression and classification problems across various fields.

### Bidirectional Long Short-Term Memory (Bi-LSTM)

A recurrent neural network (RNN) is a class of ANNs with connections between nodes forming a directed graph that corresponds to the temporal sequence of the data. LSTM is a variant of RNN capable of learning order dependency in problems involving sequence prediction. In contrast with RNN, LSTM has additional special units of memory cells that maintain information for longer periods of time than in RNN where the only historic information we have is from the previous output (Short Short-Term Memory or SSTM). In LSTM a set of input, output, update, and forget gates are used to control information flow in the model. This behavior allows the architecture of LSTM to learn more comprehensively because historic data (dependencies) are included in the learning. Bi-directional LSTM (Bi-LSTM) is an extension of traditional LSTMs that can improve model performance on sequence classification problems. Bi-LSTM performs double training on the data, first on the input sequence and second on the reverse copy of the sequence. This enables it to build additional context into the network and results in extensive learning of the underlying patterns in the training data.

### Once-Class Support Vector Machine (SVM)

One-class SVM is a variant of SVM designed for outlier or anomaly detection in data. SVM finds a hyperplane that separates two classes in a non-linear transformed feature space, whereas, one-class SVM estimates the support of a distribution by identifying regions in the input space where most of the cases lie. One class SVM may be effectively applied to imbalanced datasets where there is none or few samples of the minority class in the training set. It can also be used in cases where there is no coherent structure that can be learned by a supervised learner to separate the classes. They are capable of building context that helps them to separate one class from another especially for imbalanced datasets.

### Isolation Forest

Isolation Forest uses an ensemble of Isolation Trees, or iTrees, for the given data points to isolate anomalies. It is an unsupervised learning technique that is based on a Decision Tree that identifies anomalies by isolating outliers in the data. While most anomaly detection techniques construct a profile of what is “normal,” and then reports anything outside this “normal” as anomalous, the Isolation Forest technique isolates anomalies explicitly. The Isolation Forest assumes that anomalies are few and atypical. It randomly selects a feature and a split value within the range of typical values for that feature and recursively generates partitions on the dataset along the split value for the selected feature. The path along the splits that leads to a decision is shorter for outliers when compared to the rest of the data. Thus, an Isolation Forest builds an ensemble of iTrees for a given data set, and anomalies are those instances which have short average path lengths on the iTrees.

### Minimum Covariance Determinant (MCD)

MCD is a highly robust estimator of multivariate location and scatter. A covariance matrix is a square matrix giving the covariance between each pair of elements of a given random vector. MCD's main properties include affine equivalence, breakdown value, and influence function. Its objective is to find h set of observations out of whose n covariance matrix has the lowest determinant. MCD is very useful for outlier detection in p-variate data when p>2, because it is difficult to detect multi-class outliers by visual inspection. Many methods for estimating multivariate location and scatter break down in the presence of n=(p+1) outliers, where n is the number of observations and p is the number of variables. The MCD covariance estimator is to be applied on Gaussian-distributed data but could still be relevant on data drawn from a unimodal, symmetric distribution.

### Local Outlier Factor (LOF)

LOF is an unsupervised anomaly detection method for finding anomalous data points by computing the local density deviation of a given data point with respect to its neighbors. It considers as outliers the samples that have a substantially lower density than their neighbors. Outlier detection has been researched in machine learning alongside clustering techniques. From the viewpoint of a clustering technique, outliers are objects not located in clusters of a dataset, usually called noise. The set of points classified as noise by a clustering technique, however, is highly dependent on the particular technique and on its clustering parameters. Outlier detection typically regards being an outlier as a binary property in which a data point is an outlier or not based on some criteria. In some scenarios, it may be meaningful to assign each object a degree of being an outlier. In this case, every data point with some degree of variance from a consideration point is calculated for outlier-ness. This degree is called the local outlier factor (LOF) of an object. It is local in the sense that the degree depends on how isolated the object is with respect to the surrounding neighborhood. Outlier factor has been studied under two main categories. The first category is distribution-based, where a standard probability distribution (e.g. Normal, Poisson, etc.) is used to fit the data best. The second category is depth-based, where each data object is represented as a point in a space and is assigned a depth. In depth-based outlier detection, outliers are more likely to be data objects with smaller depths.

eXtreme Gradient Boosting (XGBoost)

XGBoost is a popular and efficient open-source implementation of the gradient boosted trees technique. Tree boosting is highly effective and has found application in several machine learning and data mining problems. Gradient boosting is a supervised learning technique that attempts to accurately predict a target variable by combining an ensemble of estimates from a set of simpler and weaker models. XGBoost is a scalable machine learning system for tree boosting. The scalability of XGBoost is due to several important optimizations, including a novel tree learning technique for handling sparse data, and a theoretically justified weighted quantile sketch procedure that enables handling instance weights in approximate tree learning. Parallel and distributed computing makes learning faster which enables quicker model exploration. XGBoost performs well in machine learning competitions because of its robust handling of a variety of data types, relationships, distributions, and the number of tunable hyperparameters. XGBoost has been applied for regression, classification (binary and multiclass), and ranking problems on tabular datasets.

### Methodology

Embodiments of the present disclosure leverage the different machine learning techniques discussed in the previous section to train models for classification. Each embodiment includes a model that is trained under the same settings for all three datasets in each experiment to ensure consistency in the results during comparative analysis. The dataset is a publicly-available dataset. The numbers of train and test samples are shown in Table 3. The datasets have been preprocessed such that the sequence labels are sectioned into separate classes where each row represents a sequence of message identifiers.

Bi-LSTM is tested and trained on a Dell GPU and the rest of the models are tested and trained in the Amazon SageMaker environment. All the model embodiments that were trained and tested in SageMaker are custom models, except for XGB which was built into SageMaker.

The Bi-LSTM model is a sequential network of three dense layers with “ReLu” activation function; the optimizer is “adam”, the loss is “mse” and the network was trained for 1,000 epochs.

MLP has 15 hidden layers, the solver value is “Ibfgs” and L2 regularization parameter is 1e-5.

Isolation Forest is set to a contamination of 0.9 and the behavior value is “new”.

MCD is set to a contamination of 0.9.

LOC is set to a contamination of 0.1.

For one-class SVM, nu is 0.99999, the kernel is linear, and gamma is 0.1.

For XGBoost, max_depth=5, eta=0.2, gamma=4, min_child_weight=6, subsample=0.8, silent=0, objective=binary: logistic and num_round=50. It was trained and tested on an “ml.m4.xlarge” CPU instance.

### Performance

The performance metrics for each embodiment include accuracy score (AC), true negative (TN), false positive (FP), false negative (FN), true positive (TP), AUC, recall (RE), specificity (SP) and F1 score.

Accuracy score (AC) is the ratio of correct predictions to the total number of input samples. Accuracy (alone) does not provide sufficient context to the functioning of the 1553 system since accuracy can be high when the number of anomalous data is very few when compared to normal data—accordingly, the models were not evaluated by accuracy alone.

TN is the number of malicious samples that were correctly classified as malicious. The best value for this metric is the total number of malicious samples.

FP is the most crucial value of the 1553 performance metrics. The smaller the FP is, close to zero, the better. FP is the number of malicious samples that were not correctly classified—this means an intrusion was classified as legitimate. Classifying an anomaly as an FP indicates success of the attacker and can have catastrophic effects to the 1553 aircraft system.

FN is the number of normal messages that were classified as malicious. Although this value should be kept to a minimum, it does not pose as much threat to the aircraft system as the FP.

TP is the number of normal samples that were truly classified as normal. TPs are very crucial in the functioning of the 1553 system because it is desired to detect all of the attacks. The best value for this metric is the total number of normal samples.

Area Under the Curve (AUC) Receiver Operating Characteristics (ROC) curve (AUC-ROC curve, AUROC, or simply AUC) describes the diagnostics ability of a binary classifier model at various threshold settings. ROC is a technique originally used in signal processing for visualizing the balance between the true positive rate and false positive rate at different parameter adjustments. AUC indicates whether the classifier has learned to differentiate the classes involved in the problem. For the 1553 dataset with two classes, normal and malicious, an AUC value greater than 0.5 indicates that the model recognizes the separate classes, an AUC value of 0.5 indicates that the model could not learn from the training set and is merely guessing (a random classifier and, usually, such models could perform better with more data or longer training), and an AUC value smaller than 0.5 indicates that the model learned the classes incorrectly.

Recall (RE) indicates the fraction of total relevant samples that were correctly classified.

Specificity (SP) is the proportion of truly negative classes that were correctly predicted as negative.

F1 score is a measure of the test accuracy.

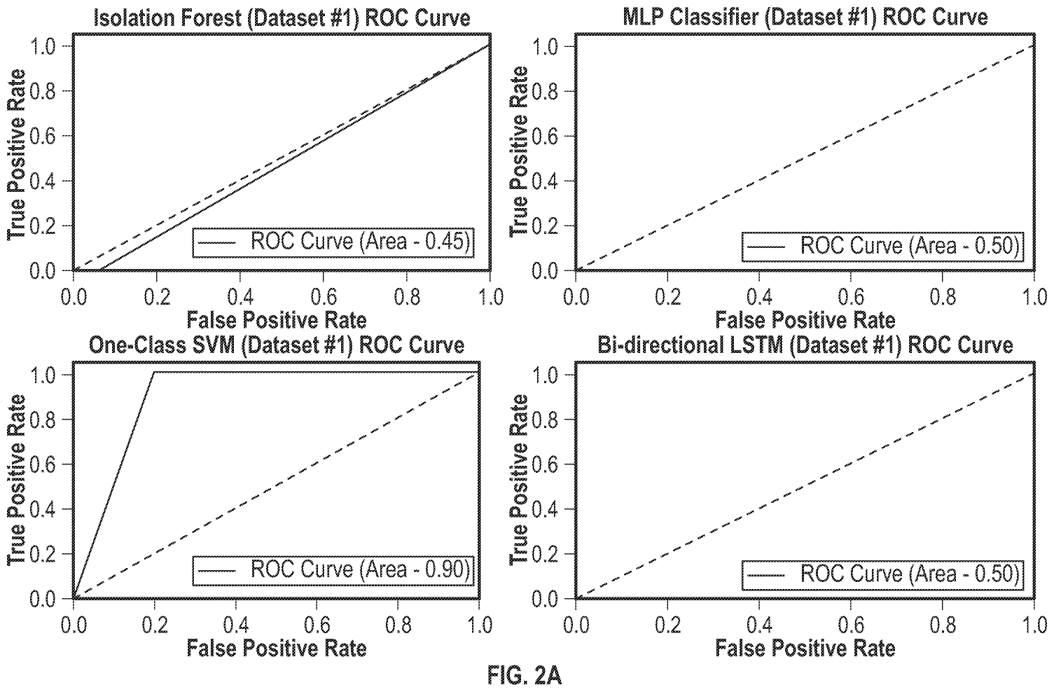

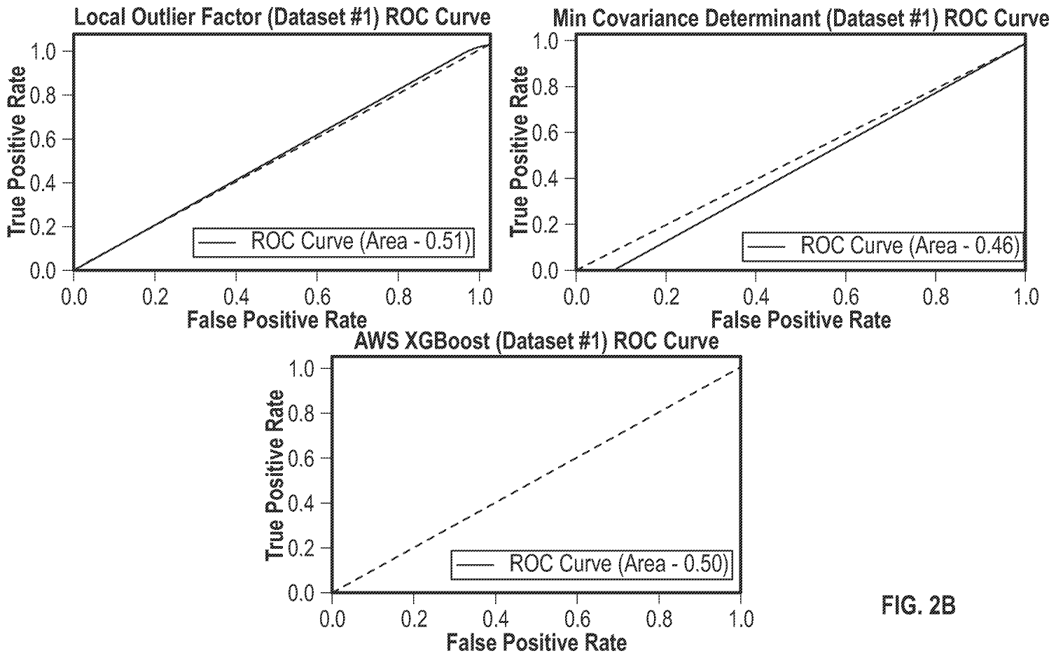

Table 4 shows the data results. FIGS. 2A and 2B show AUC curves for the models.

Judging the performance using accuracy for each model yields a totally different picture than the true performance of the models. It is important to analyze the relevance of the values in the performance matrix within the context of the prediction problem that is being solved using these models.

The 1553 system is a military mission critical system which has a very low fault tolerance to false positives, because any intrusion that is not detected can have catastrophic effects on the aircraft. Due to this fact, one preferred embodiment yields zero false alarms and undetected anomalies, and correctly classifies the entire dataset, i.e., those with close to zero false positives and false negatives. An embodiment with zero false alarms and zero undetected anomalies will have an accuracy of 100%, an AUC of 1.0, and an SP of 1.0.

Another preferred embodiment yields zero (or very low) false positives and some false negatives, since a false positive can have catastrophic effects on the aircraft system. This embodiment has a zero (or very low) false positive as well as a good AUC and accuracy. Zero false positives indicates that all attacks to the aircraft are properly categorized as an attack without any exception or misclassification. False negatives indicate that a real message is misclassified as an attack. This embodiment also has a small number of false negatives, so that, for the case of misclassifying a legitimate message, the subsystem that sent the misclassified message can resend the message with a good chance of not being misclassified the second time.

Table 4 shows that the MLP embodiment has good accuracy and recall values and it classifies all normal messages without having any false negatives. This is seen in the RE of 1. However, it fails to detect the malicious messages as seen by the SP of 0. The AUC score of 0.5 for MLP also shows that it has not learned the structure of the data and may not properly distinguish the normal from the malicious samples.

The Bi-directional LSTM embodiment may perform less-optimally at classifying the dataset by misclassifying all the normal messages. Although the data show that it detected all the malicious data points (zero false positives for all three datasets), it has falsely classified all normal data points as malicious. The Recall and AUC show it has no dependable knowledge of the dataset.

The one-class SVM embodiment performs considerably well at classifying the 1553 dataset. The AC is a correct representation of how much it learned from the dataset. This embodiment identifies the malicious samples and normal samples correctly in most cases. For dataset 1 with 1,690 negative samples, the FP is zero (messages) indicating that all the anomalies were classified correctly. For dataset 2 with 190 negative samples, the FP is 114 (messages). For dataset 3 with 20 negative, FP is 5 (messages). The RE and F1 score are also considerably high. The one-class SVM embodiment out-performs all the other models for these datasets. This can be seen by the AUC values (greater than 0.5), which show that the one-class SVM embodiment learned the dataset and has intelligently classified the input samples based on the appropriate classes.

The Isolation Forest embodiment does not have a bad AC but under-performs as it fails to properly classify any of the malicious messages (i.e., SP of 0) even though the F1 score looks good. The RE shows it did well on the average at classifying the positive samples. Though the Isolation Forest embodiment appears to succeed in classifying the normal messages, as the AUC score suggests (˜0.45 or ˜90% of 0.5), this embodiment did not learn to predict correctly and hence will be working no better than a random classifier.

The MCD embodiment achieved good AC, RE and F1 score. It also successfully classifies most of the normal samples but does poorly on the malicious samples. Only a few of the malicious samples are classified correctly in the experiment for datasets 2 and 3, and none for dataset 1. In such cases, providing more data to the model for training or training the model for a longer period of time may increase performance. Looking at the AUC score, which is slightly above the 0.5 threshold in dataset 3, this embodiment did some learning and can be expected to perform better with more training or parameter adjustments.

The LOF embodiment has poor AC, and AUC shows that the classifier has not learned to classify better than randomly.

Though the XGBoost embodiment produces the best F1 score on average for the three datasets, it under-performs significantly on FP. It properly classifies the normal samples but fails to classify any of the malicious samples. Due to how well it classified the positive samples, it has an RE of 1 and an F1 score of 0.99. The SP of 0 and AUC of 0.5 show that this embodiment has not learned to properly classify the dataset.

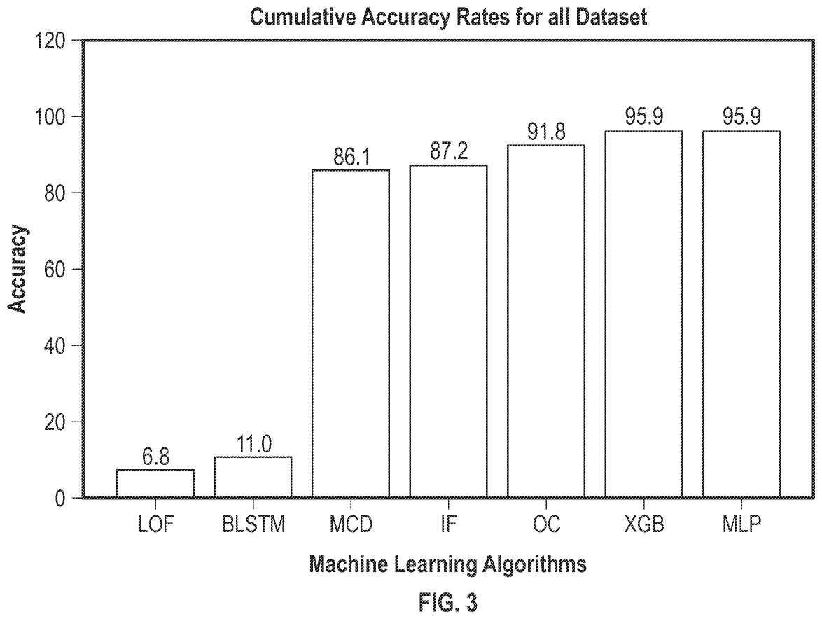

FIG. 3 depicts the cumulative accuracy score of the various machine learning models after classifying MIL-STD-1553 datasets.

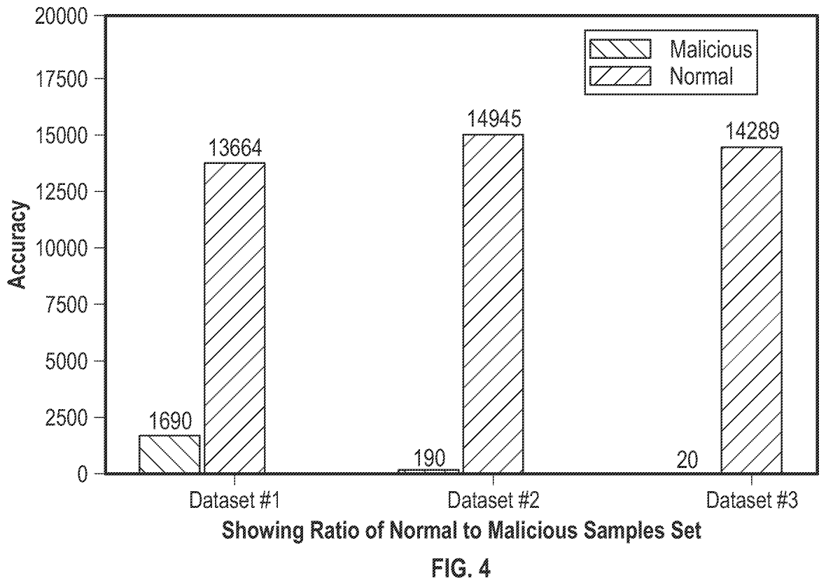

FIG. 4 depicts the ratio of test to train samples in the datasets.

The many features and advantages of the disclosure are apparent from the detailed specification, and, thus, it is intended by the appended claims to cover all such features and advantages of the disclosure which fall within the scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

TABLE 1
Format of MIL-STD-1553 Nonsequential Simulated Messages

| | | | | | | Sec. | | Dst. | | | | | | | |
|---|---|---|---|---|---|---|---|---|---|---|---|---|---|---|---|
| | | Model | | Com. | Sec. | Sub. | Dst. | sub. | Word | | | | | is | is |
| Timestamp | Error | code | ch. | Type | Add. | Add. | Add. | Add. | Count | dw₀ | dw₁ | . . . | dw₃₁ | Malicious? | Injected? |
| 1529353253315 | False | True | A | BC_RT | N/A | N/A | 0 | 31 | 0 | N/A | N/A | | N/A | False | False |
| 1529353253317 | False | True | A | RT_BC | 0 | 31 | N/A | N/A | 1 | 1\|2\|0 | N/A | | N/A | False | False |
| 1529353253321 | False | False | A | RT_RT | 1 | 2 | 2 | 1 | 2 | 0 | −1 | | N/A | True | True |
| 1529353253323 | False | True | A | BC_RT | N/A | N/A | 0 | 31 | 0 | N/A | N/A | | N/A | False | True |
| 1529353253324 | False | True | A | RT_BC | 0 | 31 | N/A | N/A | 1 | 1\|2\|0 | N/A | | N/A | False | True |
| 1529353253325 | False | False | A | RT_RT | 1 | 2 | 2 | 1 | 2 | 0 | 0.125 | | N/A | False | True |

TABLE 2
Format of MIL-STD-1553 Sequential Simulated Messages

| Seq. # | Seq. in SPMF Format | Label |
|---|---|---|
| 1 | 2-13-14-15-16-11-12-13-14-15-1-2 | NORMAL |
| 2 | 2-16-14-15-16-11-1 12-13-14-15-1-2 | MALICIOUS |
| 3 | 2-13-14-15-16-11-12-13-14-15-1-2 | NORMAL |

TABLE 3
Shows the Distribution of the Normal and Malicious
Samples Across the Three Datasets

| | | Dataset # 1 | Dataset # 2 | Dataset # 3 |
|---|---|---|---|---|
| Train Set | Normal | 1278 | 3029 | 6013 |
| | Malicious | 0 | 0 | 0 |
| Test Set | Normal | 13664 | 14945 | 14289 |
| | Malicious | 1690 | 190 | 20 |

TABLE 4
Results Showing Performance Metrics of Different Machine Learning Models

| | AC | TN | FP | FN | TP | AUC | RE | SP | F1 |
|---|---|---|---|---|---|---|---|---|---|
| | DATASET 1: Positive Samples: 13664; Negative Samples: 1690 | | | | | | | | |
| MLP | 88.9 | 0 | 1690 | 0 | 13664 | 0.5 | 1 | 0 | 0 |
| Bi-Dir LSTM | 11.0 | 1690 | 0 | 13666 | 0 | 0.5 | 0 | 1 | 0 |
| One-Class | 82.3 | 1690 | 0 | 2716 | 10948 | 0.90 | 0.8 | 0.13 | 0.89 |
| Iso Forest | 82.6 | 0 | 1690 | 968 | 12696 | 0.46 | 0.93 | 0 | 0.91 |
| Min. Cov. Det | 81.6 | 0 | 1690 | 1131 | 12535 | 0.46 | 0.92 | 0 | 0.90 |
| Loc Out Fac | 15.9 | 1635 | 55 | 12857 | 807 | 0.51 | 0.06 | 0.67 | 0.1 |
| AWS XGB | 89.0 | 0 | 1690 | 0 | 13664 | 0.5 | 1 | 0 | 0.99 |
| | DATASET 2: Positive Samples: 14945; Negative Samples: 190 | | | | | | | | |
| MLP | 98.7 | 0 | 190 | 0 | 14945 | 0.5 | 1 | 0 | 0 |
| Bi-Dir LSTM | 11.0 | 190 | 0 | 14945 | 0 | 0.5 | 0 | 1 | 0 |
| One-Class | 95.4 | 76 | 114 | 580 | 14365 | 0.68 | 0.9 | 0.01 | 0.98 |
| Iso Forest | 90.18 | 0 | 190 | 1296 | 13649 | 0.46 | 0.91 | 0 | 0.95 |
| Min. Cov. Det | 89.0 | 4 | 186 | 62 | 14883 | 0.51 | 0.99 | 0 | 0.99 |
| Loc Out Fac | 3.18 | 174 | 16 | 14479 | 466 | 0.06 | 0.73 | 0.03 | 0.06 |
| AWS XGB | 98.7 | 0 | 190 | 0 | 14945 | 0.5 | 1 | 0 | 0.99 |
| | DATASET 3: Positive Samples: 14289; Negative Samples: 20 | | | | | | | | |
| MLP | 99.9 | 0 | 20 | 0 | 14289 | 0.5 | 0.99 | 0 | 0 |
| Bi-Dir LSTM | 11.0 | 20 | 0 | 14289 | 0 | 0.5 | 0 | 1 | 0 |
| One-Class | 97.6 | 15 | 5 | 340 | 13949 | 0.87 | 0.98 | 0 | 0.99 |
| Iso Forest | 89.2 | 0 | 20 | 1519 | 12770 | 0.45 | 1.0 | 0 | 0.94 |
| Min. Cov. Det | 87.8 | 6 | 14 | 2238 | 12051 | 0.57 | 0.84 | 0 | 0.91 |
| Loc Out Fac | 1.53 | 18 | 2 | 14087 | 202 | 0.06 | 0.01 | 0.08 | 0.03 |
| AWS XGB | 99.9 | 0 | 20 | 0 | 14289 | 0.5 | 1 | 0 | 0.99 |

1. A method of applying machine learning to determine whether communications on a MIL-STD 1553 bus are normal or malicious, where sequences of message identifiers of one or more datasets form the input to one or more machine learning models.

2. The method of claim 1, further comprising:
training one or more machine learning models to detect malicious communications on the MIL-STD 1553 bus.

3. The method of claim 2, further comprising detecting malicious communications in non-sequential message datasets with a minimal number of false positives.

4. The method of claim 1 where each dataset represents a stream of simulated 1553 bus traffic and is separated into a training set and a testing set.

5. The method of claim 3, where the training set contains normal messages and the testing set contains both normal and malicious messages.

6. A method of applying a plurality of machine learning models in order to classify normal data points (benign messages) and malicious data points (anomalous messages) on 1553 datasets, comprising:
performing comparative analysis of performance of machine learning models to classify sequences of 1553 data sets and identify malicious communications; and
using the results of the comparative analysis applying metrics to judge the performance of the machine learning models applied to imbalanced 1553 data sets.

7. The method of claim 6, further comprising pre-processing MIL-STD 1553 data sets into one or more separate classes.

8. The method of claim 7, where each row of the one or more separate classes represents a sequence of message identifiers.
